(19) United States
(12) Patent Application Publication
(10) Pub. No.: US 2023/0078474 A1
(43) Pub. Date: Mar. 16, 2023

(54) ADJUSTMENT DEVICE, AND METHOD FOR ASSEMBLING

(71) Applicant: MCi (Mirror Controls International) Netherlands B.V., Woerden (NL)

(72) Inventors: Marinus ROOSE, Woerden (NL); Stefan Fritz BROUWER, Schoonhoven (NL)

(73) Assignee: MCi (Mirror Controls International) Netherlands B.V., Woerden (NL)

(21) Appl. No.: 17/909,081

(22) PCT Filed: Mar. 4, 2021
(86) PCT No.: PCT/NL2021/050151

§ 371 Date: Sep. 2, 2022

(30) Foreign Application Priority Data
Mar. 5, 2020 (NL) 2025061

(51) Int. Cl. B60R 1/074; H02K 7/116; H02K 7/14; F16H 1/16

(52) U.S. Cl. CPC B60R 1/074; H02K 7/1166; H02K 7/14; F16H 1/16

(57) ABSTRACT

The invention relates to an adjustment device for adjusting the position of an adjustable element. The device comprises a base frame for attachment to the adjustable element, an output shaft rotatably coupled to the base frame, an electric motor held by the base frame, and a worm gear assembly for transmitting rotation of the electric motor to the output shaft. The worm gear assembly includes a first worm gear and corresponding first worm. The output shaft is provided with the first worm gear coaxially disposed about a central axis of the output shaft. The first worm gear is substantially rotationally coupled or fixed to the output shaft, is held in the base frame, and is in engagement with the first worm gear. The adjustment device is arranged such that the base frame and the output shaft are rotatable with respect to each other over an angle of at least 120°.

The invention relates to an adjustment device for adjusting the position of an adjustable element.

Adjustment device for adjusting the position of an adjustable element are known, and may for example be used adjust a position of a mirror element, such as a mirror cap or a mirror glass carrier, a camera, such as a security camera or a vehicle mounted rearview camera, an antenna element, such as an adjustable element of a satellite receiver antenna, a solar panel, or another adjustable element.

It is an object of the present disclosure to provide an alternative adjustment device, in particular an adjustment device for adjusting the position of an adjustable element. It can be an object of the present disclosure to provide an adjustment device which may be relatively simple to produce, for example to facilitate providing relative low costs adjustable appliances. In embodiments, the present disclosure may aim to provide an adjustment device for adjusting the position of an adjustable element which may enable that an adjustable element may be adjusted in a relatively efficient and/or relatively effective manner, preferably in a relatively cost efficient and/or relative error prone manner. In embodiments, the present disclosure aims at providing an adjustment device for adjusting the position of an adjustable element which preferably may be relatively robust.

Thereto, the present disclosure provides for an adjustment device for adjusting the position of an adjustable element, comprising a base frame for attachment to the adjustable element, an output shaft rotatably coupled to the base frame, an electric motor held by the base frame, and a worm gear assembly for transmitting rotation of the electric motor to the output shaft, wherein the worm gear assembly includes a first worm gear and a corresponding first worm, wherein the output shaft is provided with the first worm gear, wherein the first worm gear is coaxially disposed about a central axis of the output shaft, wherein the first worm gear is substantially rotationally coupled or fixed to the output shaft, wherein the first worm is held in the base frame and is in engagement with the first worm gear, and wherein the adjustment device is arranged such that the base frame and the output shaft are rotatable with respect to each other over an angle of at least 120°.

Preferably, the adjustment device can be arranged such that the base frame and the output shaft are rotatable with respect to each other over an unlimited angle.

By arranging the adjustment device such that the base frame and the output shaft are rotatable with respect to each other over a relatively large angle, preferably an angle of at least 90°, more preferably at least 120°, for example at least 160°, such as at least 180°, it can be facilitated to adjust an adjustable device, or adjustable element thereof, provided with such adjustment device over a relatively large angle in a relatively simple manner and/or in a relatively efficient manner.

Regarding the adjustable element to be adjusted by the adjustment device, it is noted that the adjustment device may for instance a rear view device for a motor vehicle, and that the adjustable element may, for example then, be an adjustable mirror element, for example a mirror cap being adjustable with respect to a body of a motor vehicle or an adjustable mirror glass carrier which for example may be adjustable relative to a mirror cap and/or relative to the body of the motor vehicle. The adjustable element may alternatively be formed by a camera, such as for example a vehicle mounted rearview camera. Alternatively, the camera may be another camera, for example a security camera, which for example may be adjustable mounted to a building or other object. As another example, the adjustable element may be formed by a solar panel or part thereof. As yet a further example, the adjustable element may be an antenna element, for example an adjustable element of a satellite receiver antenna, in particular a so-called parasitic element or passive radiator, which may comprise one or more reflectors and/or one or more directors. However, it will be appreciated that the adjustable element to be adjusted by the adjustment device can be or can comprise any type of other adjustable element, such as for example a blind element or other sun protection element.

In embodiments of the adjustment device, the output shaft is provided with an output gear mount which is arranged for mounting an output gear, for example a pinion for meshing with a face gear, to the output shaft. Alternatively or additionally, the output shaft, in particular a distal end thereof, can be provided with the output gear, which for example may be formed by a pinion for meshing with a face gear.

For example in such embodiments of the adjustment device, the adjustment device may be mounted to an adjustable element which is to be adjusted at least partly by said adjustment device. In particular, the base frame of the adjustment device may be mounted to the adjustable element.

An adjustable device comprising the adjustable element may further comprise a second part, preferably a stationary element, which may be mounted to the fixed world. The adjustable element to be adjusted by the adjustment device may be movably mounted to the second element, preferably pivotably connected thereto. Said stationary element or other second element of the adjustable device may be provided with a main gear which may be engaged by the output gear of the adjustment device.

In embodiments, the output gear of the adjustment device and the second gear provided at the second part of the adjustable device may both be formed as a respective gear for meshing with each other, preferably having central axes intersecting at an angle of 90°. By letting the electric motor held by the base frame of the adjustment device rotate the output gear, the adjustable element to be adjusted which is provided with said adjustment device may be rotated with respect to the second element of the adjustable device about the central axis of the output gear in case the second gear is kept still.

Alternatively, the second element of the adjustable device may be provided with the adjustment device, in particular in a manner in which the base frame of the adjustment device is fixed with respect to the fixed world, and the output gear of the adjustment device may then engage a gear provided at the adjustable element to be adjusted. By letting the electric motor of the adjustment device drive the output gear, for instance when the gear provided at the adjustable element to be adjusted is kept still with respect to said adjustable element to be adjusted, the adjustment device may then rotate the adjustable element to be adjusted.

In advantageous embodiments, the adjustable device may comprise the first adjustment device, as well as a second adjustment device, which for example can be of substantially the same design as the first one. For example, the first adjustment device may be for adjusting the position of an adjustable element of said adjustable device about a first pivot axis, while the second adjustment device may be for adjusting the position of said adjustable element a second pivot axis, for example transverse to the first pivot axis, as is for example often the case in mirror adjustment systems. However, other arrangements having at least a first adjustment device and a second adjustment device are possible as well.

In advantageous embodiments, the base frame of both adjustment devices may be fixedly mounted to a first adjustable element, which is to be adjusted, and in particular mounted in a manner that both output shafts are in line with each other, and such that output gears, for example formed as pinions, provided at said output shafts both engage a third gear, for example a face gear, mounted to a second element of the adjustable device with respect to which second element the first adjustable element is to be adjustable. The third gear can thus be fixed with respect to the so-called fixed world. By rotating the output gears of the two adjustment devices in the same rotational direction with respect to a shared central axis, the first adjustable element can be rotated with respect to the second element about said shared central axis. By rotating the output gears of the two adjustment devices in opposite rotational direction with respect to the shared central axis, the first adjustable element can be rotated with respect to the second element about a central axis of the third gear, which extends transverse to said shared central axis of the output gears of the two adjustment devices.

However, alternative arrangements may be possible as well, for instance an alternative arrangement in which the adjustable device may also comprise two adjustment devices, which for example can be of substantially the same design. For example, the base frame of a first one of said adjustment devices may be fixed with respect to the adjustable element to be adjusted and the base frame of a second one of said adjustment devices may be fixed with respect to the second element of the adjustable device, and may therefore be fixed with respect to the fixed world. The output gear of the first adjustment device may then engage the output gear of the second adjustment device. When the output gear of the first adjustment device is rotated and the output gear of the second adjustment device is held still, the adjustable element to be adjusted can be rotated in a first rotational direction, especially in a rotational direction about the central axis of the output gear of the first adjustment device, whereas when the output gear of the second adjustment device is rotated and the output gear of the first adjustment device is held still, the adjustable element to be adjusted can be rotated in a second rotational direction, especially in a rotational direction about the central axis of the output gear of the second adjustment device.

It will be appreciated that by simultaneously driving both output gears, which engage each other, the adjustable element to be adjusted can be rotated simultaneously about both central axes of these output gears.

In further embodiments, the output shaft of the adjustment device may be a hollow shaft. This may for example allow cabling to extend there through. The cabling may also extend through the output gear, which in particular can be formed as a pinion, such as for example a spur pinion or a helical pinion, and may also extend through a corresponding gear, which in particular may be formed as a face gear arranged for meshing with the output gear.

Since the adjustment device is arranged such that the base frame and the output shaft are rotatable with respect to each other over an angle of at least 120°, and preferably over an unlimited angle, which for example can be advantageous when the adjustment device is for adjusting an antenna element, and which is contrary to the design of conventional motorized mirror cap adjustment devices which are for instance used for adjusting the mirror cap with respect to a vehicle, when adjusting the rotational position of the base frame of the adjustment device with respect to the output shaft, it does not seem possible, at least not in a relatively simple manner, to make use of stops or stop surfaces to define an end position of the mutual rotation between the base frame and the output shaft. In particular, such conventional motorized mirror cap adjustment devices, or so-called power fold devices, are usually used to adjust the mirror cap between two end positions, in particular between a park position or fold-in position in which the mirror cap may be substantially parallel with the lateral side of the motor vehicle and a use position or fold-out position in which the mirror cap extends substantially traverse to the lateral side of the motor vehicle. In both end positions, respective co-operating stop surfaces may cause that the rotation stops, and for instance upon sensing an increased current or a decreased voltage across the electric motor which exceeds a certain threshold value, the motor may be switched off. Once the electric motor has been turned off, the mirror cap will then be kept in its desired end position substantially free of play.

Since the adjustment device of an advantageous aspect of the present disclosure is, contrary to most conventional power fold devices, not intended to be mainly adjustable from one end position to an opposite end position, and vice versa, but is preferably also suitable to be adjusted to intermediate positions, for instance, in cases in which the adjustable element is an adjustable antenna element, an intermediate position which is to be chosen depending on an actual position of a satellite, the adjustment device can be arranged to let the adjustment, of the base frame with respect to the output shaft, stop also at one or more intermediate rotational positions. This may for example be done using one or more position sensors or rotational sensors or the like, or by any other suitable means, as will be understood by the person skilled in the art.

However, especially in cases where no stop surfaces are used to define the position at which the mutual rotation between the base frame and the output shaft has to stop, the adjustment device may encounter play when the rotation is stopped at a certain rotational position, in particular when said certain rotational position is not an end position.

It may be an aim of an aspect of the present disclosure to provide an adjustment device which may counteract such play.

Thereto, a further aspect of the present disclosure provides for an adjustment device for adjusting the position of an adjustable element, comprising a base frame for attachment to the adjustable element, the adjustment device further comprising an output shaft rotatably coupled to the base frame and extending through a first receiving opening provided in said base frame, the output shaft comprising an output shaft part, which output shaft part can for instance be a main part of said output shaft or which can for instance be formed by a separate part substantially rotationally coupled or fixed to the main part of the output shaft, said output shaft part being provided with a laterally protruding portion, the adjustment device further comprising an electric motor held by the base frame, the adjustment device further comprising a worm gear assembly for transmitting rotation of the electric motor to the output shaft, which worm gear assembly is operationally coupled with said electric motor, said worm gear assembly including a first worm gear and a corresponding first worm, the output shaft being provided with said first worm gear, said first worm gear being coaxially disposed about a central axis of the output shaft and substantially rotationally fixed or coupled to said output shaft, the first worm being held in the base frame and being in engagement with the first worm gear, and the adjustment device further comprising an intermediate part which is provided between the first worm gear and a portion of the base frame provided with the first receiving opening, said intermediate part being substantially rotationally fixed or coupled to the first worm gear and substantially rotationally coupled or fixed to the output shaft, for instance via the separate part if present, wherein the portion of the base frame provided with the first receiving opening is clamped between the laterally protruding portion of the output shaft and the intermediate part, wherein the intermediate part is provided with at least one first coupler and the output shaft part is provided with at least one second coupler for coupling with said at least one first coupler, wherein said first and second couplers are arranged such as to allow that the intermediate part and the output shaft part can be moved with respect to each other in an axial direction of a central axis of the output shaft, wherein said first and second couplers comprise corresponding first stop surfaces for limiting the rotational movement of the intermediate part with respect to the output shaft part in a first rotational direction about said central axis, wherein the first worm gear is provided with at least one first run-on surface, wherein said first run-on surface engages a corresponding third run-on surface provided at the intermediate part such that upon moving the first worm gear in the axial direction towards the intermediate part, the first run-on surface, when pushing against the third run-on surface, can cause the intermediate part to rotate in the first rotational direction with respect to the first worm gear.

Advantageously, also within said aspect of the present disclosure, the adjustment device can be arranged such that the base frame and the output shaft are rotatable with respect to each other over an angle of at least 120°, for example at least 160°, such as at least 180°.

As a result of the cooperating first run-on surfaces, preferably under the influence of a spring biasing the said first worm gear towards the intermediate part and the laterally protruding portion provided at the output shaft, the first worm gear may push the intermediate part in the first rotational direction with respect to the output shaft part until their first stop surfaces abut. Then, said cooperating first stop surfaces can prevent any further mutual rotation between the intermediate part and the output shaft part in said first rotational direction, whereas the first run-on surfaces, preferably under the influence of such a biasing force, can prevent that said intermediate part and the output shaft part can rotate with respect to each other in an opposite rotational direction. Therefore, play in a rotationally coupling between the intermediate part and the output shaft part can be prevented, as a result of which play in a rotationally coupling between the first worm gear and the output shaft can be counteracted to a relatively large extent, or can even be prevented substantially, in particular in a relatively elegant and/or relatively fool-proof and/or relatively cost efficient manner.

In advantageous embodiments of the present disclosure, for instance according embodiments according to the above mentioned aspect, the adjustment device may further comprise further play suppression means, embodiments of which will be discussed below. Such further play suppression means may in particular be advantageous when being arranged for suppressing play between the first worm gear and the first worm, but alternatively or additionally play suppression means may be provided for suppressing play between other elements.

Advantageous embodiments according to aspects of the present disclosure are described in the appended claims

By way of non-limiting examples only, embodiments of the present disclosure will now be described with reference to the accompanying figures in which:

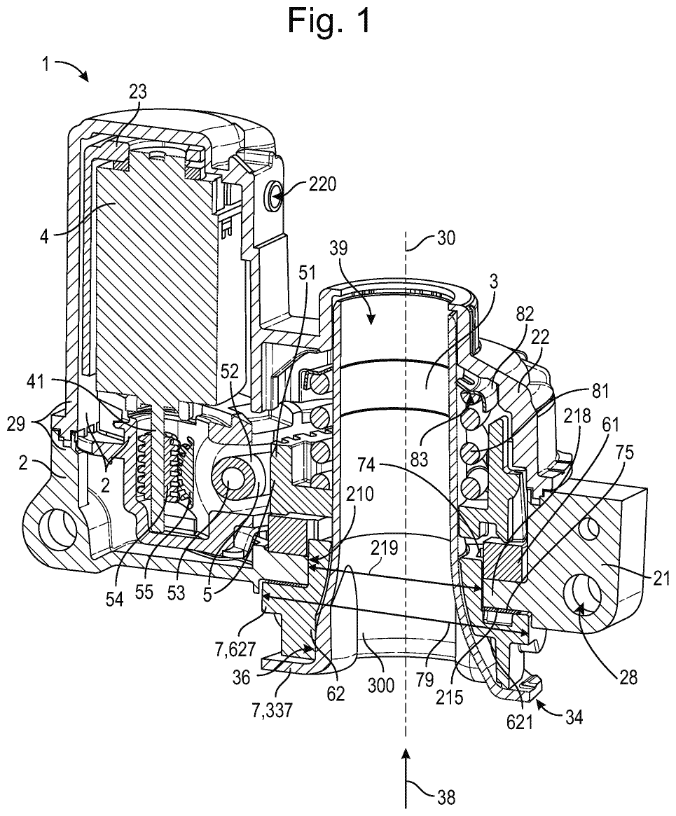

FIG. 1 shows a schematic perspective cross-sectional partly cut-away view of a first embodiment of an adjustment device according to an aspect of the present disclosure;

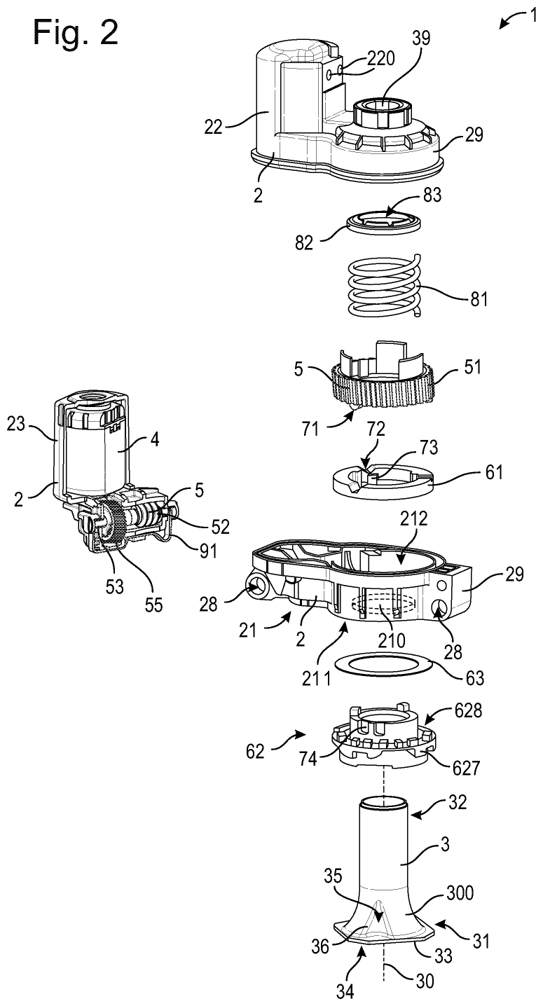

FIG. 2 shows a schematic perspective exploded view of the adjustment device of FIG. 1;

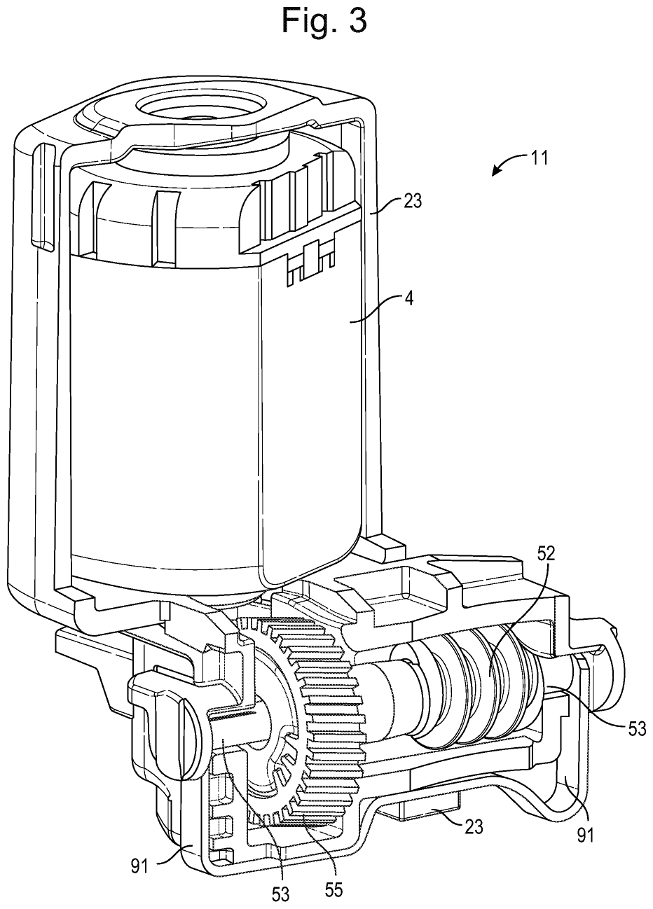

FIG. 3 shows a perspective partly cut-away view of a sub-assembly of the adjustment device of FIGS. 1 and 2;

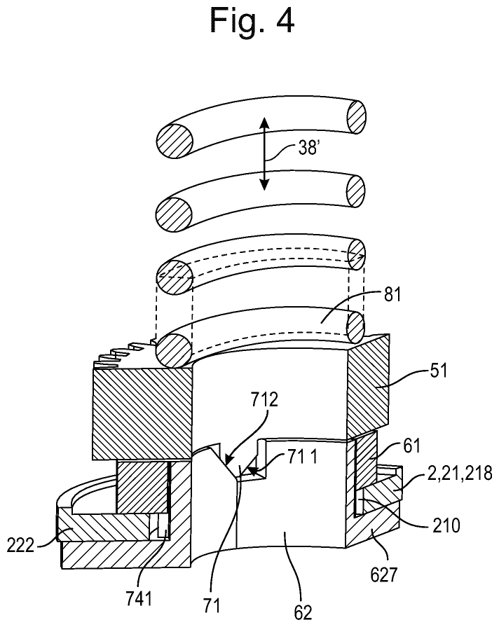

FIG. 4 shows a perspective partly cut-away view of a portion of an alternative embodiment of an adjustment device according to an aspect of the present disclosure;

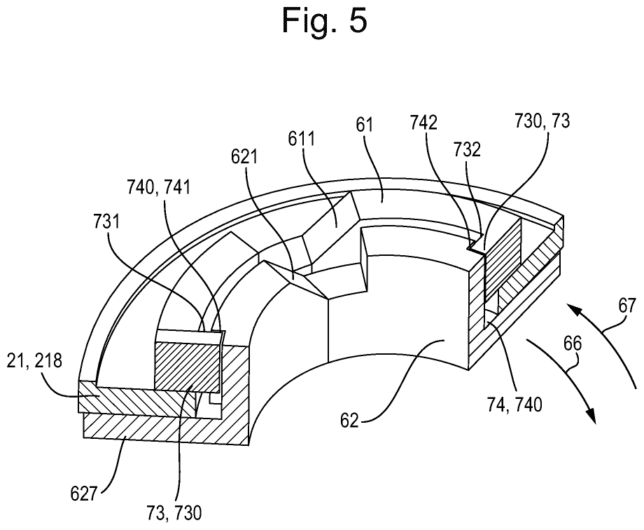

FIG. 5 shows a perspective partly cut-away view of the adjustment device of FIG. 4 in which even more is cut-away;

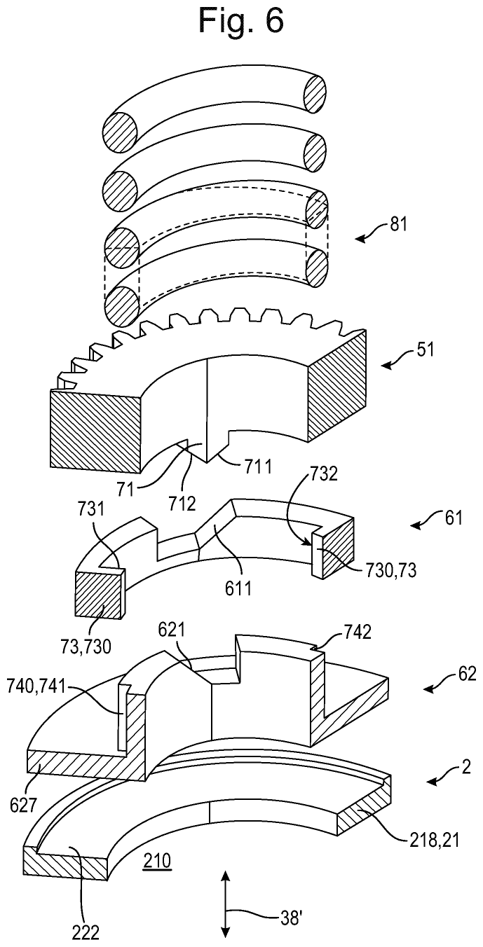

FIG. 6 shows a perspective partly cut-away exploded view of the adjustment device of FIG. 4; and

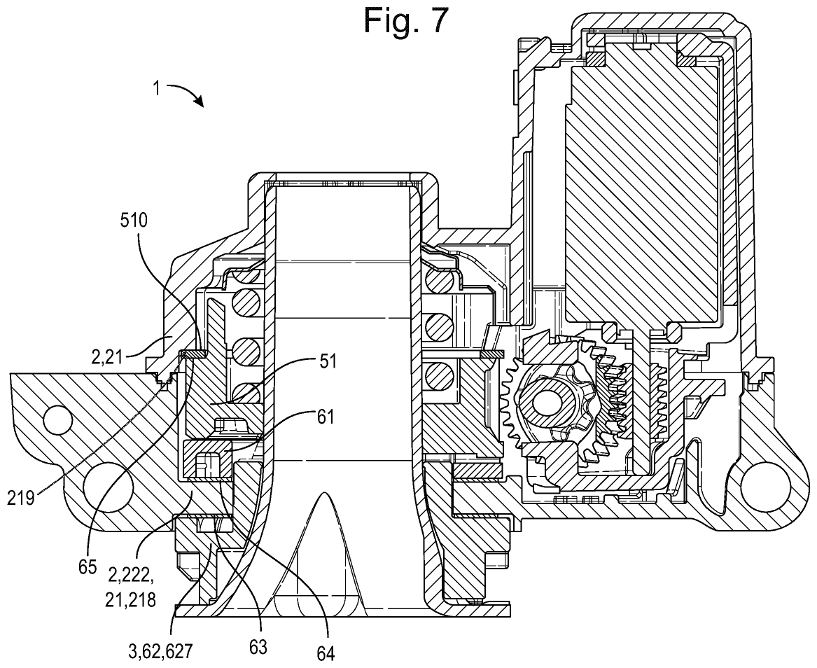

FIG. 7 shows a schematic cross-sectional view of a further embodiment of an adjustment device according to an aspect of the present disclosure.

It is noted that the figures show merely a preferred embodiment of an adjustment device according to an aspect of the present disclosure. In the figures, the same or similar reference signs or numbers refer to equal or corresponding parts.

FIGS. 1 and 2 show an adjustment device 1 for adjusting the position of an adjustable element.

Said device 1 comprises a base frame 2 for attachment to the adjustable element, and an output shaft 3 which is rotatably coupled to the base frame 2, as a result of which the output shaft 3 can be rotated with respect to said base frame 2.

Although the base frame 2 may be comprised of a single frame part 21, it may in alternative embodiments, for instance as is the case in the exemplary embodiment shown in the figures, comprise multiple frame parts 21, 22, 23.

Additionally or alternatively, the base frame 2 may be formed at least partly by a housing 21, 22, wherein the housing 21, 22 may house components of the adjustment device 1 which are for adjusting the rotational position of the output shaft 3 with respect to the base frame 2. The housing 21, 22 may comprise one or multiple housing parts 21, 22, and may, and the base frame 2 may, at least in embodiments, include one or more further frame parts 23, which may for example be mounted within the housing 21, 22.

In the here shown embodiment, the base frame 2 comprises a first frame part 21, which forms a first housing part 21, and a second frame part 22, which forms a second housing part 22, and the base frame 2 further comprises a third frame part 23. Said third frame part 23 is in the here shown embodiment for holding certain components 4, 52, 53, 91 of the adjustment device 1, such as to enable assembling a sub-assembly 11, which may be mounted to the first frame part 21 and/or the second frame part 22, in particular housed within a housing 29 formed by the first housing part 21 and the second housing part 22.

Further, the adjustment device 1 comprises an electric motor 4 which is held by the base frame 2, preferably by an additional frame part 23 of said base frame 2 which is for forming a sub-assembly 11.

The device 1 further comprises a worm gear assembly 5 for transmitting rotation of the electric motor 4 to the output shaft 3. The worm gear assembly 5 includes a first worm gear 51 and a corresponding first worm 52. The first worm gear 51 is provided on the output shaft 3 in a manner that it is coaxially disposed about a central axis 30 of said output shaft 3. In the here shown embodiment, the first worm gear 51 is formed as a separate part, and thus not being an integral part of the output shaft 3. However, in alternative embodiments the first worm gear 51 may be formed as an integral part of the output shaft 3, and as such thus be rotationally fixed to a main part 300 of the output shaft 3. Also in other embodiments, the first worm gear 51 is substantially rotationally fixed or coupled to the output shaft 3, for instance by means of a breakaway coupling or a so-called self-releasing coupling, which will be discussed later on.

It is noted that, additionally to the first worm gear 51 and the corresponding first worm 52 of the worm gear assembly 5, the adjustment device 1 may comprise further gears 54, 55 for transmitting rotation of the electric motor 4 to the output shaft 3 of the device 1, and that said further gears 54, 55 and the worm gear assembly 5 may thus be parts of gear train for transmitting rotation of the electric motor 4 to the output shaft 3. In embodiments, such as for example in the here shown embodiment, the gear train may comprise a second worm 54, which is substantially rotationally coupled or fixed to a motor shaft 41 of the electric motor 4, and a corresponding second worm gear 55 functionally engaging said second worm 54. Said second worm gear 55 may for example be rotationally coupled to the first worm 52, for example by rotationally coupling said second worm gear 55 to a worm shaft 53 on which the first worm 52 is provided as well in a rotationally coupled manner.

The first worm 52, which is held in the base frame 2, for example in the additional frame part 23, is in engagement with the first worm gear 51. As such, by rotating the first worm 52 by means of the electric motor 4 to which it is functionally coupled, for example by means of one or multiple intermediate gears 54, 55, the first worm gear 51 can be rotated, and as such the output shaft 3 which is rotationally coupled with said first worm gear 51 can thus be rotated with respect to the base frame 2. It will be appreciated that the rotation of the output shaft 3 is a relative movement relative to the base frame 2, and that for example in case in which the output shaft 3 is held stationary with respect to the fixed world, the output shaft 3 will not rotate with respect to the fixed world when being rotated with respect to the base frame 2, but the base frame 2 will be rotated with respect to the fixed world.

For example in order to allow for a relatively large adjustment angle, the adjustment device 1 is arranged such that the base frame 2 and the output shaft 3 are rotatable with respect to each other over an angle of at least 120°.

Advantageously, the adjustment device 1 can be arranged such that the base frame 2 and the output shaft 3 are rotatable with respect to each other over an unlimited angle. This means that, at least in some embodiments, the base frame 2 and the output shaft 3 can be rotated with respect to each other over more than 360°. The device 1 can thus be free of any stops or stop surfaces limiting the rotation of the base frame 2 and the output shaft 3 with respect to each other and/or free of any stops or stop surfaces limiting the rotation of the base frame 2 and the first worm gear 51 with respect to each other.

In embodiments, the output shaft, in particular a first end 31 thereof, which for example may be formed by its distal end 31, can be provided with an output gear. The output gear can preferably be formed by a pinion, such as for instance a spur pinion or a helical pinion, which can then be arranged for meshing with a crown gear or a face gear, the latter which is for example known from page 162 and further of “Zahnradtechnik Evolventen-Sonderverzahnungen”, by Karlheinz Roth, published by Springer 1998. The output gear may alternatively be formed by another type of gear, such as for example a face gear.

In embodiments, the output gear can be integrally formed with the output shaft 3, for example by injection molding. It will be appreciated that the output gear 3 may comprise multiple parts, such as for instance at least a main part 300 and a separately formed part 62 which may be rotationally coupled to said main part 300, for instance by means of a form lock. Said separately formed part 62 may for instance be a plastic molded part 62, whereas the main part 300 may for instance be formed from metal. For instance in such embodiments, but also in other embodiments, the output gear may for instance be integrally formed by such part 62 of the output shaft 3 formed separately from the main part 300 thereof.

Although the output gear can in embodiments thus be integrally formed with the output shaft 3, for example by means of injection molding, the output gear may in alternative embodiments be formed by a separate part which is fixed to the output shaft 3.

In order to facilitate mounting an output gear to the output shaft 3, in particular to its distal end 31, the output shaft 3 may be provided with an output gear mount 33 which is arranged for mounting an output gear thereto, as is the case in the exemplary embodiment shown in the figures. Said mount 33 may for example comprise a support surface 34 for supporting the output gear there against and may additionally or alternatively comprise one or more connectors, for example formed as connector holes for receiving screws or other connector means such as bolts, rivets, etc. Although the output gear mount 33 may in embodiments be formed by a main part 300 of the output shaft 3, the output gear mount 33 may in alternative embodiments be formed by another part of the output shaft 3, such as for example by a separately formed part 62 which may be rotationally coupled to the main part 300, such that said parts 62, 300 cannot rotate with respect to each other. Said separately formed part may for example also form a laterally protruding portion 7; 337, which will be discussed below.

Although the output gear may thus be formed by a part separately formed from the one or multiple parts 300, 62 forming the output shaft 3, said output gear may in alternative embodiments thus be formed by one or multiple parts 300, 62 of said output shaft 3.

As is the case in the here shown embodiment, the base frame 2 can for example comprise a first base frame part 21, wherein said first base frame part 21 comprises a first receiving opening 210 into which the output shaft 3, especially a second end 32 which may be formed by a proximal end 32 of said output shaft 3, has been inserted from a first side 211 of the first base frame part 21. Preferably, the output shaft 3 may be provided with a laterally protruding portion 7; 337, 627 having a width 79 which can prevent that the output shaft 3, when being inserted into the first receiving opening 210 in an insertion direction extending from the first side 211 of the first base frame part 210 towards the opposite, second side 212, can entirely pass through said first receiving opening 210. Said first receiving opening 210 may thus have a width 79 being smaller than the outer width 79 of the laterally protruding portion 7; 337, 627. In embodiments said laterally protruding portion 7 may be an integral part 337 of the output shaft 3, for example an integral part that also forms a mount 33 for an output gear. However, in other embodiments, the laterally protruding portion 7 may be formed by a separate part 62, which may be rotationally coupled to a main part 300 of the output shaft 3, in particular by means of a form lock, as is the case in the here shown embodiment in which inwardly protruding portions of said separate part 62 that forms the laterally protruding portion 7 are interlocked with corresponding inwardly extending cavities 36 provided at the output shaft 3.

It will be appreciated that a contact surface between a surface 75 of the laterally protruding portion 7 facing the first side 211 of the first base frame part 210 and a corresponding surface 215 located at said side 211 of the first base frame part 210 which faces said laterally protruding portion 7 may be arranged to form a smooth contact surface enabling said surfaces 75, 215 to be moved over each other during use in rotation direction about the central axis 30 of the output shaft 3 over an angle of at least 120°, and preferably over an unlimited angle. For example thereto, these surfaces may be free of interlockable cams or the like. Preferably, at least one of said surfaces 75, 215 may be substantially flat or so-called smooth, and may thus be free of any protrusion behind, and cavity in which, any unevenness of the other one of said surfaces 75, 215 could interlock.

In the here shown embodiment, the surface 75 facing of the laterally protruding portion 7 which faces the first side 211 of the first base frame part 210 is provided with cams 628. This may be due to that the separate part 62 forming said laterally protruding portion 7 can be an off-the-shelf part, which for example can be also used in the assembly of wing mirror adjustment devices, such as so-called power fold devices, in which such cams 628 may be of particular use for particular functions which may not be desired in an adjustment device 1. Thereto, the corresponding surface 215 formed by the first base frame part 210 may preferably be substantially smooth, or may be at least free of a cam pattern which corresponds with the pattern of the cams 628 of the laterally protruding portion 7 in a manner which would enable interlocking of them. Alternatively, or additionally, for example when the corresponding surface 215 is provided with a cam surface corresponding with the cam surface of the laterally protruding portion 7, an intermediate element 63 may be located between the two facing surfaces 75, 215. Said intermediate element 63 may be rotationally coupled to one of the output shaft 3 and the first base frame part 210, but, alternatively, may preferably be rotatable with respect to both in order to counteract unnecessary friction when rotating the output shaft 3 and the base frame 2 with respect to each other. Although, at least in embodiments, the intermediate element 63 may be considered to be part of the first base frame part 210 or part of the output shaft 3, respectively, and may then thus provide one of the two facing surfaces 75, 215, it may alternatively be considered as a first bearing element 63, in particular a plain bearing element 63, provided between said two facing surfaces 75, 215. Preferably, the first bearing element 63, if any, may be substantially ring-shaped, as can be seen in FIG. 2. Although the first bearing element 63, which may thus be a first bearing ring 63, may for instance be formed out of metal plate material, the first bearing element 63 may alternatively be formed from any other suitable material and/or in any suitable manner.

In embodiments, such as for example in an embodiment as described here above and such as for example in the embodiments shown in the figures, the first worm gear 51 can be mounted to the output shaft 3 at the second side 212 of the first base frame part 21. Said first worm gear 51, which is substantially rotationally coupled to the output shaft 3, may be directly rotationally coupled therewith, for example by means of a form lock, or may be indirectly rotationally coupled with the output shaft 3, as for instance is the case in the here in FIGS. 1-3 shown embodiment in which the first worm gear 51 is rotationally coupled with an intermediate part 61 provided between the first worm gear 51 and the first base frame part 21, and which intermediate part 61 is in turn rotationally coupled with the output shaft 3, which in the here shown embodiment is done by rotationally coupling said intermediate part 61 with the separate part 62, which is an output shaft part of the output shaft 3, and which forms the laterally protruding portion 7, which separate part 62 is rotationally coupled with a main part 300 of the output shaft 3. Preferably, said intermediate part 61 can be formed as a cam ring 61.

It will be appreciated that one or more of such one or more substantially rotationally fixed or coupled couplings may be formed as releasable couplings, for example couplings formed by corresponding engaging cam surfaces 71, 72 and/or one or more other protrusions 73 which may interlock with one or more corresponding other cavities 74.

One or more rotationally coupled couplings may be releasable, which means that after such releasing, the parts previously rotationally coupled or fixed to each other do not any longer need to rotate together when one of these parts is being rotated. Thereto, at least one rotationally coupled coupling 71, 72 between two respective elements 51, 61 coupled to each other may not form an axial coupling preventing said two respective elements 51, 61 to move with respect to each other in the axial direction of the central axis 30 of the output shaft 3. For example, as is the case in the here shown embodiment and can be seen in FIG. 2, the first worm gear 51 can be provided with first cam surfaces 71 for couplingly engaging corresponding second cam surfaces 72, wherein said second cam surfaces 72 can then be provided directly on the output shaft 3, in particular on a main part of said output shaft 3, or can be provided on a part 61, 62 rotationally coupled or fixed to the main part 300 of the output shaft 3, and can then preferably be provided on the intermediate part 61, which intermediate part 61 can be a part of the output shaft 3. The first cam surfaces 71 can then be biased in axial direction of the output shaft 3 towards the second cam surfaces 72, for example by means of a spring 81. Said spring may be a compression spring and/or a spiral spring, which may be provided around the output shaft 3. Further, said spring 81 may be locked by means of locking element 82, which may be mounted onto the output shaft 3, in particular at or near a proximal end 32 of said output shaft. Preferably said locking element 82 may be fixed to the output shaft 3 by means of an interference fit, in particular a press fit. Advantageous, the adjustment device 1 is arranged such that such releasable coupling uncouples upon applying a torque exceeding a certain threshold value, for example a threshold value of at least 20 N·m, preferably at least 25 N·m, such as at least 30 N·m.

It will be appreciated that in alternative embodiments of the adjustment device 1, the first worm gear 51 may, directly or indirectly, be rotationally coupled to the output shaft 3 by means of any other type of breakaway coupling or a so-called self-releasing coupling which allows uncoupling when a certain torque is applied which exceeds a certain threshold value. Preferably, said threshold value can be at least 20 N·m, for example at least 25 N·m, such as at least 30 N·m.

In other embodiments, alternatively, or additionally, another breakaway coupling or so-called self-releasing coupling may be provided for uncoupling a coupling between the output shaft 3 and the base frame 2 when a torque exceeding a certain threshold value is exceeded, said threshold value can for example be at least 20 N·m, such as at least 25 N·m, or at least 30 N·m. Alternatively or additionally, in case the adjustment device 1 comprises the output gear, a rotationally coupled coupling between said output gear and the output shaft 3 may be releasable, in particular when a torque exceeding a certain threshold value is exceeded, said threshold value can for example be at least 20 N·m, such as at least 25 N·m, or at least 30 N·m.

By arranging the adjustment device 1 such that the output shaft 3 and/or the output gear, if any, can at least partly, e.g. in a rotational direction, be releasable from the base frame 2, at least temporarily. As a result, when a relatively high torque is provided on the adjustment device 1, for example due to a storm or other weather condition or for example due to an animal or human interacting with an adjustable device, such as for example a solar panel or an antenna, of which an adjustable element is provided with the adjustment device 1, such a releasable coupling may allow that the output shaft 3 and/or the output gear can then be moved, in particular rotated, with respect to the base frame 2. This may for instance counteract damage to the adjustable device, and/or may for example counteract that the adjustable element and/or the adjustment device 1 breaks.

Although one or more of the one or more rotationally coupled or fixed couplings may be releasable, alternatively, or additionally, one or more of the one or more rotationally coupled or fixed couplings may be permanent. For example, none of these rotationally coupled or fixed couplings may be releasable. Although this may result in that the adjustment device 1 or another part of the adjustable device may break, for example under extreme weather conditions, this may on the other hand allow for a relatively simple and/or relatively cost efficient adjustment device design.

Furthermore, in embodiments of the adjustment device 1, the first worm gear 51 which is mounted to the output shaft 3 can be locked to the output shaft 3 such that the output shaft 3 cannot be pulled out of the first worm gear 51, in particular such that it cannot be pulled therefrom in a direction opposite to the inserting direction 38 in which the output shaft 3 has been inserted into the first receiving opening 210 provided in the first base frame part 21 and into the first worm gear 51. Preferably, the first worm gear 51, and/or an intermediate part 61 which may be provided between the first worm gear 51 and the first base frame part 21, may then extend radially with respect to the output shaft 3 to such extent that the first worm gear 51 cannot be pulled through the first receiving opening 210 from the second side 212 towards the first side 211 of the first base frame part 21. In such embodiments, the output shaft 3 may be provided with a stop surface 83 for counteracting that the first worm gear 51, and/or the intermediate part 61 if any, can slid off from the output shaft 3. As is for instance the case in the here shown exemplary embodiment, said stop surface 83 may for example be formed by the locking element 82 by means of which the spring 81 can be locked.

It is noted that the above-mentioned intermediate part 61 is optional, and that, in embodiments, there may be not such an intermediate part 61 or that said intermediate part 61 may be integrated with the first worm gear 51 such as to form a single part. Although the intermediate part 61 may in embodiments be omitted, this does not necessarily mean that there will then be no part or element located in-between the first worm gear 51 and the wall 222 or other portion 222 of the base frame 2, which portion 222 is provided with the first receiving opening 210 and is then clamped between the first worm gear 51 and the laterally protruding portion 627 of the output shaft 3. For example, at said location in-between the first worm gear 51 and said wall or other portion 222, a second bearing element 64, in particular a second bearing ring 64 may be provided. However, such a second bearing element 64 may of course also be present in embodiments which do comprise the intermediate part 61, in which embodiments said second bearing element 64 may be provided between said intermediate part 61 and said wall or other portion 222, as for instance can be seen in FIG. 7 which shows an embodiment substantially corresponding to the embodiment of FIGS. 1-3, but which, amongst others, also includes such a second bearing element 64.

It will be appreciated that the second bearing element 64, if any, and/or the first bearing element 63, if any, may facilitate relatively smooth rotation of the output shaft 3, which output shaft 3 may include and/or be provided with for instance the first worm gear 51 and/or the laterally protruding portion 627 and/or the intermediate element 61, if any.

Additionally or alternatively, the adjustment device may comprise one or multiple further bearing elements. For example, in embodiments, whether or not the first bearing element 63 and/or the second bearing element 64 are/is provided, a third bearing element 65 may be provided. Said third bearing element 65 may be located between an upper face 510 of the first worm gear 51 and a bottom face 219 of the base frame 2, in particular of its first base frame part 21, as can be seen in the exemplary embodiment shown in FIG. 7.

In embodiments, the third bearing element 65, and additionally or alternatively any of the other bearing elements 64, 63, in particular the second bearing element 64, if any, may be formed as or comprise a thrust washer or a thrust bearing, which can be arranged to support a relatively large axial load. This may in particular be advantageous in case the first worm gear 51 is clamped, for instance via the intermediate element 61 and the one or more bearing elements 65, 64, in-between at the one hand the wall 222 or other portion 222 of the base frame 2 and on the other hand the bottom face 219 of the base frame 2, in particular formed by its first base frame part 21.

It is noted that, for instance in such embodiments, the first worm gear 51 may thus be clamped between two parts 21, 22 of the base frame 2. For example, the first worm gear 51 may, for instance via the intermediate element 61 and the one or more bearing elements 65, 64, be clamped between the bottom face 219 of the first base frame part 21 and the wall 222 or other portion 222 of the second base frame part 22. Such embodiments may in particular be advantageous in cases in which the design of the adjustment device 1 could otherwise allow for relatively much rotational play of the first worm gear 51 with respect to the output shaft 3 and/or the main part 300 of said output shaft 3. Examples of such embodiments in which such rotational play may be counteracted relatively well will be discussed further below in the context of FIGS. 4, 5 and 6.

Advantageously, the adjustment device 1 is arranged such that the output shaft 3 may not unintentionally be pulled out or otherwise removed from the base frame 2.

For example thereto, the adjustment device 1 may be assembled by means of a method including a step of providing at least a first base frame part 21 of the base frame 2, wherein said first base frame part 21 is provided with a first receiving opening 210. Upon providing the output shaft 3, it may be inserted through the first receiving opening 210 from a first side 211 of the first base frame part 21. Further, the first worm gear 51 can be provided, and it may be mounted onto the output shaft 3 at a second side 212 of the first base frame part 21 opposite to the first side 211. It will be appreciated that said first worm gear 51 may be mounted onto the output shaft 3 after said output shaft 3 has been inserted through the first receiving opening 210. However, alternatively, the first worm gear 51, and one or multiple intermediate parts 61 which optionally may be provided between the first worm gear 51 and the first base frame part 21, may be put in place at the second side 212 of the first base frame part 21 prior to, or at least partly simultaneously with, inserting the output shaft 3 into the first receiving opening 210, such that upon insertion of the output shaft 3 into said opening 210 said output shaft may simultaneously be inserted into the first worm gear 51, and into one or multiple intermediate parts 61, if present.

By subsequently locking the first worm gear 51 to the output shaft 3 to such extent that the output shaft 3 can subsequently not be pulled out of the first worm gear 51 in a direction opposite to the inserting direction 38, the output shaft 3 may also be prevented from being pulled out of the first base frame part 21, in particular due to that the first worm gear 51, and/or one or multiple intermediate parts 61 optionally provided between the first worm gear 51 and the first base frame part 21, having an outer width larger than the width 219 of the opening 210.

Advantageously, the first base frame part 21, in particular a portion 218 thereof provided with the first receiving opening 210, may be held, in particular in a manner in which it is substantially fixed in the direction of the output shaft's central axis 30, between, at the first side 211, the laterally protruding portion 7; 337, 627 provided on the output shaft 3, and, at the second side 212, the first worm gear 51 or a respective one 61 of one or multiple optionally provided intermediate parts 61.

Besides, it is noted that the adjustment device 1 may further comprise play suppression means. Such play suppression means may in particular be for suppressing play between the first worm gear 51 and the first worm 52, but alternatively or additionally play suppression means may be provided for suppressing play between other elements, in particular other elements of a drive train for rotating the output shaft 3 with respect to the base frame 2.

In preferred embodiments, such as for example is the case in the here shown exemplary embodiment, and can be seen relatively well in FIG. 3, the first worm 52 can be rotationally, and preferably also axially, coupled or fixed to the second worm gear 55 or alternatively to another element for directly driving said first worm 52 during use.

Additionally, or alternatively, in preferred embodiments, the first worm 52 can provided on a worm shaft 53 and can then be both axially and rotationally coupled or fixed to said worm shaft 53. Said worm shaft 53 can then be biased in an axial direction of the worm shaft 53, preferably by means of an resilient element 91. In particular, the resilient element 91, which may be formed by a leaf spring 91 or other spring, may be held in a respective frame part 23, in particular by partly restraining it in said frame part 23, for example in a manner as shown in FIG. 3.

The resilient element 91 may be in contact with at least one end, and for example both ends 531, 532, of the worm shaft 53. It will be appreciated that the resilient element 91, which may thus be formed as a leaf spring 91, which in particular can be made of sheet material, more in particular spring steel, may facilitate distributing forces applied by a respective end 531, 532 of the worm shaft 53. In particular, said leaf spring 91 or other resilient element may facilitate distributing such forces over a relatively large surface area of a respective frame part 23, 22, 21 of the base frame 2, such as for instance the third frame part 23, which respective frame part 23, 22, 21 may for instance be made of plastic material which may be more vulnerable and/or less wear-resistant than the material, such as for example spring steel, of the leaf spring 91 or other resilient element 91. This may counteract that in process of time the worm shaft 53 may unintentionally let the respective frame part 23, 22, 21 collapse. It is appreciated that although the resilient element 91 may thus form a force distributing element at one or at both ends 531, 532 of the worm shaft 53, in alternative embodiments other force distributing elements may be provided, for instance in the form of one or more plates or sheet elements, for example of metal or any other suitable material. It is noted that said force distributing element, which may thus be formed by the resilient element 91 or other metal element, may in addition to, or even alternatively to, facilitating such a force distribution purpose may serve as a bearing element facilitating a relatively smooth rotation of the worm shaft 53.

By biasing the first worm 52 in its axial direction, in particular by means of the resilient element 91, the teeth of said first worm 52 can be pressed relatively firm against the teeth of the cooperating first worm gear 51, thereby suppressing play. However, alternative play suppression means, or so-called means for taking up backlash, may be provided in other embodiments.

For example, the first worm gear 51 may be a split worm gear, in particular split up in at least two parts in the axial direction of said worm gear, wherein teeth parts defined by one of the parts of said first worm gear can be slightly offset with respect to further teeth parts defined by another of the parts of said first worm gear. For example, these teeth parts may be slightly offset by means of spring force, for example more or less like in a manner as disclosed in publication U.S. Pat. No. 1,404,816 (A) or in another manner. As another example, the teeth parts may be offset during assembly of the adjustment device 1, in particular by offsetting said teeth parts to such extent that the composed teeth of the worm gear which are composed by said teeth parts are relatively tightly received in interspaces between spiral teeth portions of the first worm 52, and by then locking the parts of the first worm gear forming said teeth parts, for example more or less like in a manner as disclosed in publication U.S. 2007175295 (A1) or in another manner. Alternatively, the first worm 52 may be split up in at least two parts, which may for instance be done under spring force, and may then be done substantially perpendicular to the central axis of the worm gear, for example more or less like in a manner as disclosed in publication U.S. Pat. No. 6,386,059 (B1) or in another manner. Alternatively, the first worm 52 may be split up and may then be assembled such as to engage the first worm 51 in a relatively backless free manner, for example more or less like in a manner as disclosed in publication DE102007023161 (A1) or in another manner.

Also other alternative play suppression means may be provided, for instance by calibrating the distance between the central axis of the first worm 52 and the center of the corresponding first worm gear 51. For example, the first worm 52 may be biased in a lateral direction towards the first worm gear 51, for example more or less like in a manner as disclosed in publication EP1881237 (B1) or in another manner. It is also possible that the first worm gear 51 is biased towards the first worm 52, for example more or less like in a manner as disclosed in publication EP1911992 (B1) or in another manner. Alternatively, the distance between the central axis of the first worm 52 and the center of the corresponding first worm gear 51 can be calibrated by assembly, for example more or less like in a manner as disclosed in publication DE102010031425 (A1) or in another manner.

Yet a further example of play suppression means may comprise a so-called power split, in particular wherein there are two first worms in angular relationship, which two first worms are both meshed with the first worm gear and connected together, for example by means of a helical spring, in particular arranged more or less like in a manner as disclosed in publication U.S. Pat. No. 2,833,155 (A), or for example by means of two engaging bevel gears, in particular arranged more or less in a manner as disclosed in publication U.S. Pat. No. 1,366,770 (A), or for example by any other suitable means. Another so-called power split is also possible, for example more or less like in a manner as disclosed in publication EP2180582 (A1) in the context of the embodiment shown in its FIG. 4A, or in another suitable manner.

Yet a further example of play suppression means may comprise a so-called dimension shift, which for example is also disclosed in publication EP2180582 (A1), see in particular the embodiment shown in FIGS. 6A-6C of said publication.

Yet a further example of play suppression means may comprise a so-called shaped closed engagement between worm and worm gear, which shaped closed engagement for instance may be provided by means of a worm split into two parts each forming a split or one-half spiral thread, which may be biased with respect to each other in order to bias the spiral tooth, which is formed by these two one-half spiral threads, towards a position in which the tooth width, measured in the longitudinal direction of the worm, is relatively wide and the gaps formed between the spiral are relatively small, for example by biasing them by means of a resilient element, for example more or less in a manner as is disclosed in publication U.S. Pat. No. 1815835 (A) or in any other suitable manner. Also many other alternative means may provide for so-called shaped closed engagement between worm and worm gear. For example, the teeth of the worm gear may be deformable, preferably expandable and biased towards an expanded position, for example wherein the teeth are biased in a radially outward direction of the worm gear, for example more or less in a manner as is disclosed in publication JPS5919769 (A) in which the teeth are urged outwards by means of springs, or in any other suitable manner. Alternatively or additionally the teeth may be urged outwards in the circumferential direction of the worm gear, for example more or less in a manner as is disclosed in publication JP2012126332 (A), or in any other suitable manner. Moreover, any other suitable play suppression means may be used, as will be understood by the skilled person.

Besides, it is noted that in embodiments of the adjustment device 1, the output shaft 3 can preferably be formed as a hollow shaft thereby providing a passage 39 for allowing cabling to extend there through, which cabling, or a part of which cabling, may for example be for feeding the electric motor 4, and which may come out of an end of the passage and may then go into the housing 22, 21, for example via one or more openings 220 in respective part 22 of said housing 2. The cabling may also extend through the output gear, in particular formed as a pinion, and may then extend through a corresponding gear, in particular formed as a face gear, with which corresponding gear the output gear is engaged during use in an adjustable device, such as for example a camera, an antenna, a solar panel, etc. The output gear, and/or the output gear mount 33, if any, and/or the corresponding gear, if any, may thus also be hollow and/or be provided with a passage for allowing cabling to extend there through.

Further, the base frame 2 of the adjustment device 1 can be provided with one or multiple mounting holes 28, preferably at least two mounting holes 28, for mounting the adjustment device 1 to an adjustable element. Advantageously, the one or multiple mounting holes 28, which preferably may be provided in the first base frame part 21, may have an axial direction extending substantially transverse to the axial direction of the output shaft 3, which may facilitate mounting the adjustment device 1, for example as it may counteract that there is not enough or barely space for fasteners, such as for example screws or bolts or the like, and/or as it may counteract that there is not enough space for handling a tool for fastening or releasing such fasteners, for example as output gear is not obstructing the holes, as could be the case when the mounting holes would extend parallel with the axial direction of the output shaft 3.

FIGS. 4, 5 and 6 show partly cut-away views of an embodiment of a mechanism for mounting the first worm gear 51 onto an output shaft in a manner which can counteract or even substantially prevent play in rotational direction between said first worm gear 51 and said output shaft. Said mechanism can be implemented in an adjustment device for adjusting the position of an adjustable element. In order to show certain elements of said adjustment device that will be discussed below, other elements, such as for instance the output shaft 3, are cut-away and omitted from said FIGS. 4-6. Besides, also parts 81, 51, 61, 2, 62 which are shown in said FIGS. 4,6 have been partly cut-away, such that only portions, of about 1/3, of said parts 81, 51, 61, 2, 62 are shown here.

Said adjustment device can comprise a base frame 2 for attachment to the adjustable element. Said adjustment device, like the one in FIGS. 1, 2 and 3, comprises an output shaft 3 which is rotatably coupled to the base frame 2 and extending through a first receiving opening 210 provided in said base frame 2.

The output shaft 3 comprises an output shaft part 300, 62. Said output shaft part can for instance be a main part 300 of said output shaft 3, which can be an integral part of said output shaft 3. Alternatively, said output shaft part 300, 62 can for instance be formed by a separate part 62 which is substantially rotationally fixed to the main part 300 of the output shaft 3. Said output shaft part 62, 300 is provided with a laterally protruding portion 627, which can be dimensioned such that it is too large to pass through the first receiving opening 210.

Further, the adjustment device comprises an electric motor 4 held by the base frame 2, which is not shown in FIGS. 4-6, and a worm gear assembly 5. The worm gear assembly 5, which is for transmitting rotation of the electric motor 4 to the output shaft 3, is operationally coupled with said electric motor 4. Said worm gear assembly 5 includes a first worm gear 51, which is shown in FIGS. 4 and 6, and a corresponding first worm 52 which engages said first worm gear 51, and which first worm 52, which is held in the base frame 2, and which can be driven by means of the electric motor 4.

The output shaft 3 is provided with said first worm gear 51, and said first worm gear 51 is coaxially disposed about a central axis 30 of the output shaft 3. The first worm gear 51 is substantially rotationally coupled or fixed to said output shaft 3, which preferably is done at least via an intermediate part 61, and more preferably also via an output shaft part formed as a separate part 62 being separately formed from a main part 300 of the output shaft 3.

The adjustment device according to the embodiment of FIGS. 4-6 comprises also said intermediate part 61. Said intermediate part 61 is provided between the first worm gear 51 and a portion of the base frame 2 which is provided with the first receiving opening 210. Preferably, the intermediate part 61 is substantially annular, and may be substantially coaxially disposed about the output shaft 3. In embodiments, the intermediate part 61 may be formed as a cam ring or a coupling ring, for rotationally coupling the first worm gear 51 to the output shaft in an indirect manner.

In the adjustment device, the intermediate part 61 is thus substantially rotationally coupled or fixed to the first worm gear 51 and substantially rotationally coupled or fixed to the output shaft 3, for instance via the separate part 62 if present.

The first receiving opening 210, preferably formed as a substantially round through hole 210, is provided in a wall 222 or other portion 222 of the base frame 2. Said portion 222 of the base frame 2 provided with said first receiving opening 210 is clamped between the intermediate part 61 and the laterally protruding portion 627 of the output shaft 3, which, as is the case in the here shown embodiments, may thus be formed by a separate part 62, but which alternatively may be formed as an integral part of the output shaft 3.

As can be seen relatively well in FIGS. 5 and 6, the intermediate part 61 is provided with at least one first coupler 730, and the output shaft part 62, 300 is provided with at least one second coupler 740 for coupling with said at least one first coupler 730. Said first and second couplers 730, 740 are arranged such as to allow that the intermediate part 61 and the output shaft part 62, 300 can be moved with respect to each other in an axial direction 38′ of a central axis 30 of the output shaft 3. This may for example facilitate that, after or while the output shaft 3 including its output shaft part 62, which may be formed as a separate part 62, is inserted through the first receiving opening 210 from a first side of the wall 222 or other portion 222 of the base frame 2 provided with said opening 210, the intermediate part 61 can be placed onto said output shaft 3 from the opposite, second side of said portion 222 of the base frame 2.

The first and second couplers 730, 740 comprise corresponding first stop surfaces 731, 741 for limiting the rotational movement of the intermediate part 61 with respect to the output shaft part 62, 300 in at least a first rotational direction 66 about said central axis 30. The first and second couplers 730, 740 can preferably also comprise corresponding second stop surfaces 732, 742 for limiting the rotational movement of the intermediate part 61 and the output shaft part 62, 300 with respect to each other about said central axis in a second rotational direction 67, opposite to the first rotational direction 66.

As can be seen in FIGS. 4 and 6, the first worm gear 51 is provided with at least one first run-on surface 711. Preferably, the first worm gear 51 can be provided with at least one second run-on surface 712 as well. In such embodiments, a respective one of the one or more first run-on surfaces 711 and a respective one of the one or more second run-on surfaces 712 can both be formed by a single cam 71, as is the case in the here shown embodiment.

In advantageous embodiments, the first worm gear 51 is provided with multiple first run-on surfaces 711, especially multiple first run-on surfaces 711 defined by multiple cams 71, which preferably then also may define multiple second run-un surfaces 712. For example, at least three cams 71 are provided, which preferably are disposed about the central axis 30 in such a manner that the angle between any two adjacent ones is smaller than 180°, as a result of which the contact between the first worm gear 51 provided with said cams 71 and the intermediate part 61 can be statically determinated. Advantageously, exactly three of such cams 71 are provided, which preferably may be substantially evenly distributed about the central axis 30.

It is noted that although the first worm gear 51 is thus provided with at least one first run-on surface 711, and preferably also with at least one second run-on surface 712, it is not necessary that these one or multiple run-on surfaces are formed by the first worm gear 51, as is the case in the here shown embodiment. For example, the one or multiple run-on surfaces may in alternative embodiments be formed by a separate element which, in axial direction, can be disposed between the first worm gear 51 and the intermediate part 61. Although in such embodiments, which include a separate element comprising one or more of said one or multiple run-on surfaces, said one or more of said one or multiple run-on surfaces are thus not integrally formed with a part forming the first worm gear 51, said first worm gear 51 can then thus be provided with said separate element and can therefore thus be provided with run-on surfaces formed by said separate element.

The first run-on surface 711 engages a corresponding third run-on surface 611 provided at the intermediate part 61 such that upon moving the first worm gear 51 in the axial direction 38′ towards the intermediate part 61, the first run-on surface 711 can cause the intermediate part 61 to rotate in the first rotational direction 66 with respect to the first worm gear 51, when the first run-on surface 711 is pushed against the third run-on surface 611, for example under the influence of a spring 81 which biases the said first worm gear 51 towards the intermediate part 61 and towards the laterally protruding portion 627 provided at the output shaft 3. As a result, the first worm gear 51 may then push the intermediate part 61 in the first rotational direction 66 with respect to the output shaft part 62 until their first stop surfaces 731, 741 abut.

It is noted that the cooperating first and third run-on surfaces 711, 611, and/or the cooperating second and fourth run-on surfaces 712, 621, may preferably extend under an angle with a virtual plane which is normal to the central axis 30, wherein said angle preferably is between 25° and 65°, more preferably between 35° and 55°, yet more preferably between 40° and 50°, such as about 45°.

Although the above-mentioned angle may preferably be between 40° and 50°, it could alternatively be different. Nevertheless, it can be advantageous that the angle is at least 40°, and it may then for instance be in the range of 40° to 65°.

The spring 81 may be formed as a coil spring 81, in particular a pressure coil spring 81, and it may be disposed about the output shaft 3.

It is noted that although the spring 81 may directly push against the first worm gear 51 and may thus be in direct contact with said first worm gear 51, alternatively one or more intermediate components may be provided between the spring 81 and the first worm gear 51.

In embodiments, the spring 81 may during use of the adjustment device 1 press the first gear 51 relatively firmly in the direction of the intermediate part 61 provided with the one or more third run-on surfaces 611, if any, and/or in the direction of the output shaft part 62 provided with the one or more fourth run-on surfaces 621, if any. For example, the adjustment device 1 may be arranged such that when a certain torque or so-called moment is applied to the output gear and/or to the output gear mount 33, while the adjustment device 1 is at rest and is not adjusting, said output gear and/or the output gear mount 33 will not rotate with respect to the first gear 51 over a rotation angle of more than 1°, wherein said certain torque or moment may for instance be at least 5 N·m or for instance at least 10 N·m.

Alternatively or additionally, the first gear 51 may to some extent be locked against unintentional rotation with respect to the output gear and/or the output gear mount 33 by other means. For example, as is discussed above in the context of FIG. 7, the first gear may to some extent be locked against such unintentional rotation by means of clamping it between two parts 21, 22 of the base frame 2. For example, the first worm gear 51 may then, for instance via the intermediate element 61 and the one or more bearing elements 65, 64, be clamped between the bottom face 219 of the first base frame part 21 and the wall 222 or other portion 222 of the second base frame part 22. In such embodiments, it may be advantageous to provide a thrust washer or a thrust bearing, for instance one 65 provided between an upper face 510 of the first worm gear 51 and a bottom face 219 of the first base frame part 21 and/or one 64 provided between on the one hand a lower face of the first worm gear 51 or an intermediate element 61, if any, and on the other hand an upper face of the wall 222 or other portion 222 of the base frame 2, which wall or other portion 222 is provided with the first receiving opening 210. It will be appreciated that the clamping force by means of which the first worm gear 51 is clamped between the respective base frame parts 21, 22 may be such that when a certain torque or so-called moment is applied to the output gear and/or to the output gear mount 33, while the adjustment device 1 is at rest and is not adjusting, said output gear and/or the output gear mount 33 will not rotate with respect to the first gear 51 over a rotation angle of more than 1°, wherein said certain torque or moment may for instance be at least 5 N·m or for instance at least 10 N·m.

In advantageous embodiments, the adjustment device 1 may be arranged such that the base frame 2 and the output shaft 3 are rotatable with respect to each other over an angle of at least 120°, for example at least 160°, such as at least 180°, and the adjustment device 1 can be arranged such that the base frame 2 and the output shaft 3 are rotatable with respect to each other over an unlimited angle.

Additionally or alternatively, in embodiments comprising the at least one second run-on surface 712, said second run-on surface 712 engages a corresponding fourth run-on surface 621 which is provided at the output shaft part 62, 300, such that upon moving the first worm gear 51 in the axial direction 38′ towards said fourth run-on surface 621, in particular under action of the spring 81, the one or more second run-on surfaces 712, when pushing against the one or more fourth run-on surfaces 621, can cause said output shaft part 62, 300, to rotate in a second rotational direction 67 with respect to the first worm gear 51, said second rotational direction 67 being opposite to said first rotational direction 66.

Advantageously, said first and second stop surfaces 731, 741, 732, 742 can then provide for a rotational coupling between the intermediate part 61 and the output shaft part 62, 300, but can on the other hand then also provide some play to facilitate moving said intermediate part 61 and said output shaft part 62, 300 with respect to each other in the axial direction 38′ of the central axis 30 of the output shaft 3, for example in order to facilitate assembling the adjustment device 1.

It is noted that although an intermediate part 61, and its one or more third run-on surfaces 611 which can cooperate with the first run-on surfaces 711, may be advantageously incorporated in certain embodiments of an adjustment device 1 according to the present disclosure, the intermediate part 61 may in alternative embodiments be omitted. In such alternative embodiments, for example the one or more first run-on surfaces 711 may then be omitted on the first worm gear 51. Additionally or alternatively, features of the then omitted intermediate part 61 may then be integrated into the first worm gear 51. For instance, the one or multiple first couplers 730, if any, and/or the one or more first stop surfaces 731, if any, may be integrated in the part forming the first worm gear 51.

Furthermore, it is noted that for the purpose of clarity and a concise description features are described herein as part of the same or separate embodiments, however, it will be appreciated that the scope of the invention may include embodiments having combinations of all or some of the features described.

In particular, it is noted that the skilled person will directly understand that one or multiple features described as relating to one or more embodiments described in the context of one or more respective figures can also be used in an embodiment described in the context of other figures. For example, one or multiple features described as relating to one or more embodiments described for instance in the context of FIGS. 1-3 and/or FIG. 7 can also be used in an embodiment described in the context of FIGS. 4-6, and as another example it is noted that for instance also one or multiple features described as relating to one or more embodiments described in the context of FIGS. 4-6 and/or FIG. 7 can also be used in an embodiment described in the context of FIGS. 1-3.

Further, it is noted that the invention is not restricted to the embodiments described herein. It will be understood that many variants are possible.

Such and other variants will be apparent for the person skilled in the art and are considered to lie within the scope of the invention as formulated in the following claims

1. An adjustment device for adjusting the position of an adjustable element, comprising:
a base frame for attachment to the adjustable element;
an output shaft rotatably coupled to the base frame;
an electric motor held by the base frame; and
a worm gear assembly for transmitting rotation of the electric motor to the output shaft,
wherein the worm gear assembly includes a first worm gear and a corresponding first worm, wherein the output shaft is provided with the first worm gear, wherein the first worm gear is coaxially disposed about a central axis of the output shaft, wherein the first worm gear is substantially rotationally coupled or fixed to the output shaft, wherein the first worm is held in the base frame and is in engagement with the first worm gear, and wherein the adjustment device is arranged such that the base frame and the output shaft are rotatable with respect to each other over an angle of at least 120°.

2. The adjustment device according to claim 1, arranged such that the base frame and the output shaft are rotatable with respect to each other over an unlimited angle, i.e. over more than 360°.

3. The adjustment device according to claim 1, wherein the output shaft is provided with an output gear mount which is arranged for mounting an output gear to the output shaft.

4. The adjustment device according to claim 1, wherein the output shaft is provided with an output gear.

5. The adjustment device according to claim 4, wherein the output gear is integrally formed with the output shaft (3).

6. The adjustment device according to claim 1, wherein the base frame comprises a first base frame part, wherein the first base frame part comprises a first receiving opening into which the output shaft has been inserted from a first side of the first base frame part, and wherein the first worm gear has been mounted to the output shaft at a second, opposite side of the first base frame part.

7. The adjustment device according to claim 6, wherein the first worm gear mounted to the output shaft has been locked to the output shaft such that the output shaft cannot be pulled out of the first worm gear.

8. The adjustment device according to claim 7, wherein the first worm gear extends radially with respect to the output shaft to such extent that the first worm gear cannot be pulled through the first receiving opening from the second side towards the first side of the first base frame part.

9. The adjustment device according to claim 1, wherein the first worm gear which is substantially rotationally coupled or fixed to the output shaft by means of a breakaway coupling or a so-called self-releasing coupling which uncouples when a torque is applied which exceeds a certain threshold value.

10. The adjustment device according to claim 9, wherein the first worm gear is provided with first cam surfaces for couplingly engaging corresponding second cam surfaces, wherein said second cam surfaces are provided on the output shaft, and wherein the first cam surfaces are biased in axial direction of the output shaft towards the second cam surfaces.

11. The adjustment device according to claim 1, wherein said adjustment device further is arranged for suppressing play between the first worm gear and the first worm.

12. The adjustment device according to claim 1, wherein the first worm is biased in its axial direction.

13. The adjustment device according to claim 1, wherein the output shaft is formed as a hollow shaft thereby providing a passage for cabling.

14. The adjustment device according to claim 1, wherein the base frame is provided with one or multiple mounting holes having an axial direction extending substantially transverse to the axial direction of the output shaft.

15. An adjustment device for adjusting the position of an adjustable element, comprising:
a base frame for attachment to the adjustable element;
an output shaft rotatably coupled to the base frame and extending through a first receiving opening provided in said base frame, the output shaft comprising an output shaft part, said output shaft part being provided with a laterally protruding portion;
an electric motor held by the base frame;
a worm gear assembly for transmitting rotation of the electric motor to the output shaft, which worm gear assembly is operationally coupled with said electric motor, said worm gear assembly including a first worm gear and a corresponding first worm, the output shaft being provided with said first worm gear, said first worm gear being coaxially disposed about a central axis of the output shaft and substantially rotationally coupled or fixed to said output shaft, the first worm being held in the base frame and being in engagement with the first worm gear; and
an intermediate part which is provided between the first worm gear and a portion of the base frame provided with the first receiving opening, said intermediate part being substantially rotationally coupled or fixed to the first worm gear and substantially rotationally coupled or fixed to the output shaft,
wherein the portion of the base frame provided with the first receiving opening is clamped between the laterally protruding portion of the output shaft and the intermediate part,
wherein the intermediate part is provided with at least one first coupler and the output shaft part is provided with at least one second coupler for coupling with said at least one first coupler,
wherein said first and second couplers are arranged such as to allow that the intermediate part and the output shaft part can be moved with respect to each other in an axial direction of a central axis of the output shaft,
wherein said first and second couplers comprise corresponding first stop surfaces for limiting the rotational movement of the intermediate part with respect to the output shaft part in a first rotational direction about said central axis,
wherein the substantially rotationally coupled or fixed worm gear is provided with at least one first run-on surface,
wherein said first run-on surface engages a corresponding third run-on surface provided at the intermediate part such that upon moving the first worm gear in the axial direction towards the intermediate part, the first run-on surface, when pushing against the third run-on surface, can cause the intermediate part to rotate in the first rotational direction with respect to the first worm gear.

16. The adjustment device according to claim 15, wherein the first worm gear is provided with at least one second run-on surface, wherein the second run-on surface engages a corresponding fourth run-on surface provided at the output shaft part such that upon moving the first worm gear in the axial direction towards said fourth run-on surface, the second run-on surface, when pushing against the fourth run-on surface, can cause said output shaft part, to rotate in a second rotational direction with respect to the first worm gear, said second rotational direction being opposite to said first rotational direction.

17. The adjustment device according to claim 15, wherein said first and second couplers comprise corresponding second stop surfaces for limiting the rotational movement of the intermediate part and the output shaft part with respect to each other about said central axis in the second rotational direction.

18. The adjustment device according to claim 17, wherein said first and second stop surfaces provide for a rotational coupling between the intermediate part and the output shaft part and also provide some play to facilitate moving said intermediate part and said output shaft part with respect to each other in the axial direction of the central axis of the output shaft.

19. A method for assembling the adjustment device according to claim 1, comprising a step of:
providing at least a first base frame part of the base frame, wherein said first base frame part is provided with a first receiving opening;
providing the output shaft;
inserting said output shaft from a first side of the first base frame part through the first receiving opening;
providing the first worm gear and mounting it onto the output shaft at a second side of the first base frame part opposite to the first side; and
locking the first worm gear to the output shaft to such extent that the output shaft cannot be pulled out of the first worm gear in a direction opposite to the direction into which the output shaft has been inserted into the first receiving opening and into the first worm gear.

20. The adjustment device according to claim 4, wherein the output gear is a pinion arranged for meshing with a face gear or a crown gear.

21. The adjustment device according to claim 6, wherein an intermediate part, which is provided between the first worm gear and the first base frame part, extend radially with respect to the output shaft to such extent that the first worm gear cannot be pulled through the first receiving opening from the second side towards the first side of the first base frame part.

22. The adjustment device according to claim 9, wherein said threshold value is at least 20 N·m.

23. The adjustment device according to claim 10, wherein said second cam surfaces are provided on a main part of the output shaft and/or a part substantially rotationally coupled or fixed to the main part of the output shaft.

24. The adjustment device according to claim 12, comprising a resilient element biasing the first worm in its axial direction.

25. The adjustment device according to claim 15, wherein the adjustment device is arranged such that the base frame and the output shaft are rotatable with respect to each other over an angle of at least 120°, or at least 160°, or at least 180°.

26. The adjustment device according to claim 15, wherein the output shaft part is a main part of said output shaft.

27. The adjustment device according to claim 15, wherein the output shaft part is a separate part substantially rotationally coupled or fixed to a main part of the output shaft.

28. A method for assembling the adjustment device according to claim 15, comprising a step of:
providing at least a first base frame part of the base frame, wherein said first base frame part is provided with a first receiving opening;
providing the output shaft;
inserting said output shaft from a first side of the first base frame part through the first receiving opening;
providing the first worm gear and mounting it onto the output shaft at a second side of the first base frame part opposite to the first side; and
locking the first worm gear to the output shaft to such extent that the output shaft cannot be pulled out of the first worm gear in a direction opposite to the direction into which the output shaft has been inserted into the first receiving opening and into the first worm gear.
